(19) United States
(12) Patent Application Publication
(10) Pub. No.: US 2026/0340167 A1
(43) Pub. Date: Oct. 29, 2026

(54) SYSTEMS AND METHODS FOR MULTI-CLOUD ACCESS USING CREDENTIAL EXCHANGE

(71) Applicant: Capital One Servics, LLC, McLean, VA (US)

(72) Inventor: Jinlian WANG, Falls Church, VA (US)

(73) Assignee: Capital One Servics, LLC, McLean, VA (US)

(21) Appl. No.: 19/190,537

(22) Filed: Apr. 25, 2025

(51) Int. Cl. G06F 21/62; H04L 9/32

(52) U.S. Cl. CPC G06F 21/6218; H04L 9/32; G06F 2221/2141

(57) ABSTRACT

A device may receive, from a resource of a source cloud, a source request to access resources of a target cloud. The source request may originate from a multi-cloud application on the resource. The source request may indicate a source credential for a source profile. The device may transmit, to the source cloud, a validation request to validate the source credential, and receive, from the source cloud, a validation indication that the source credential is valid. The device may determine whether the source profile has been authorized to access a target profile in the target cloud. The device may transmit, to the target cloud, a credential request for a target credential for the target profile, and receive, from the target cloud, the target credential for the target profile. The device may transmit, to the resource of the source cloud, the target credential for the target profile.

### BACKGROUND

Applications running in one cloud computing platform may face challenges when accessing resources hosted in another cloud computing platform. This may occur in multi-cloud environments, where multiple cloud computing platforms can be leveraged to enhance availability or utilize a mix of services. Authentication and access in multi-cloud environments may be overly complex and cumbersome, and/or may lack a sufficient level of security and consistency.

### SUMMARY

Methods and systems are described herein for novel uses and/or improvements to authentication and access in multi-cloud environments. As one example, methods and systems are described herein for facilitating credential exchange across multiple cloud computing platforms to enable secure and reliable multi-cloud resource utilization.

Cloud computing platforms provide scalable and on-demand computing resources, including processing power, storage, and networking capabilities. Thus, cloud services can be used to deploy applications efficiently while reducing infrastructure management overhead. In conventional cloud computing environments, applications are hosted on a single cloud computing platform, which can lead to limitations in terms of availability, performance, compliance, and resource optimization. To address these challenges, multi-cloud environments can be used to utilize resources from multiple cloud computing platforms. In a multi-cloud environment, an application can distribute workloads across different cloud computing platforms to utilize the platforms’ geographic distribution or computing capabilities

However, authentication and access in multi-cloud environments can be complex, and lacking sufficient security and consistency needed for real-time use. For example, complex authentication and access schemes may involve too much latency to be invoked at application runtime, thereby limiting their applicability and effectiveness. Moreover, if such schemes are utilized during application runtime, they may produce significant delays that lock up allocated cloud resources for excessive time durations, thereby affecting efficient cloud resource allocation. Furthermore, the lack of security and consistency in authentication and access schemes may lead to the loss of multi-cloud capabilities in applications, thereby impairing interoperability, service availability (e.g., leaving applications more susceptible to service outages and downtime), and efficient multi-cloud resource utilization. For example, single-cloud resource usage may be less efficient than multi-cloud configurations, thereby leading to excessive use of processing and memory resources.

Methods and systems disclosed herein enable secure and reliable authentication and access in multi-cloud environments. For example, a credential system may be used to provide seamless interoperability across cloud computing platforms at application runtime. The credential system facilitates the establishment of trust between two sets of identities across different cloud computing platforms through the exchange of messages by the credential system. For example, a source profile in a source cloud computing platform and a target profile in a target cloud computing platform may be registered with the credential system using sequences of messages between the credential system and one or more user devices. The registration may involve temporary credentials for the source profile and the target profile being provided to the credential system, and the credential system validating the temporary credentials through messaging with the source cloud computing platform and the target cloud computing platform. The use of the temporary credentials provides a secure registration procedure that establishes long-term secure use of the credential system. Once registered, through additional sequences of messages between the credential system and one or more user devices, the source profile can be approved to use the target profile for accessing resources in the target cloud computing platform. This approval messaging provides an additional layer of security for establishing long-term secure use of the credential system.

At runtime of an application on a resource in the source cloud computing platform, credentials for the source profile can be used to obtain credentials for the target profile through an exchange by the credential system. The exchange involves additional sequences of messages between the credential system, the source cloud computing platform, and the target cloud computing platform to support a secure and reliable credential issuance each time an application requests an exchange. This consistency enables applications to seamlessly receive credentials for outside cloud computing platforms in a fast and efficient manner suitable for runtime. In this way, the credential system supports multi-cloud resource utilization, particularly in real-time application use cases. Accordingly, the credential system enhances interoperability between different cloud computing platforms, improves the availability of multi-cloud services by facilitating the use of geographically distributed cloud resources across multiple cloud computing platforms, and enables efficient multi-cloud resource utilization. Thus, by enabling multi-cloud resource utilization, the credential system conserves processing and memory resources that otherwise would be used less efficiently in a single-cloud setup.

In some aspects, the system may receive, via a first application programming interface (API) from a resource of a source cloud computing platform, a source request to access resources of a target cloud computing platform, where the source request originates from a multi-cloud application on the resource of the source cloud computing platform, and where the source request indicates a temporary source credential for a source profile authorized in the source cloud computing platform, and indicates a target identifier for a target profile authorized in the target cloud computing platform. The system may transmit, via a second API to the source cloud computing platform and based on the source request, a validation request to validate the temporary source credential. The system may receive, via the second API from the source cloud computing platform and in response to the validation request, a validation indication that the source credential is valid, where the validation indication includes a source identifier for the source profile. The system may determine, using a database lookup based on the source identifier and the target identifier, whether the source profile has been authorized to access the target profile. The system may transmit, via a third API to the target cloud computing platform and based on determining that the source profile has been authorized to access the target profile, a credential request for a temporary target credential for the target profile. The system may receive, via the third API from the target cloud computing platform and in response to the credential request, the temporary target credential for the target profile. The system may transmit, via the first API to the resource of the source cloud computing platform, the temporary target credential for the target profile to be used by the multi-cloud application to access the resources of the target cloud computing platform.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-1F show an example environment for multi-cloud access using credential exchange, in accordance with one or more embodiments.

FIG. 2 shows illustrative components for a system used to enable multi-cloud resource utilization, in accordance with one or more embodiments.

FIG. 3 shows a flowchart of the steps involved in enabling multi-cloud resource utilization, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

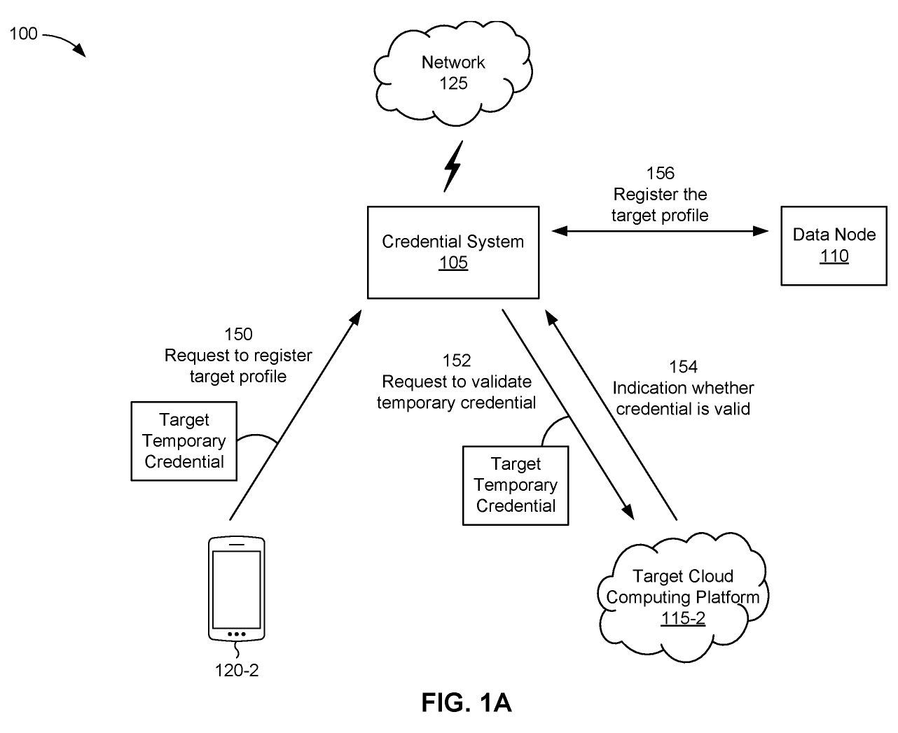

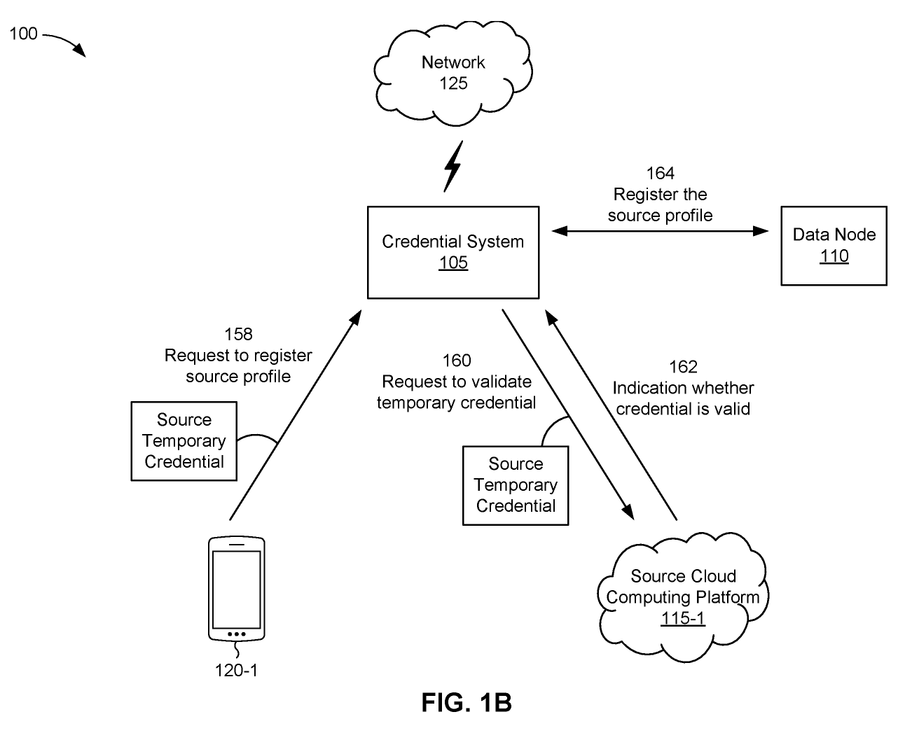

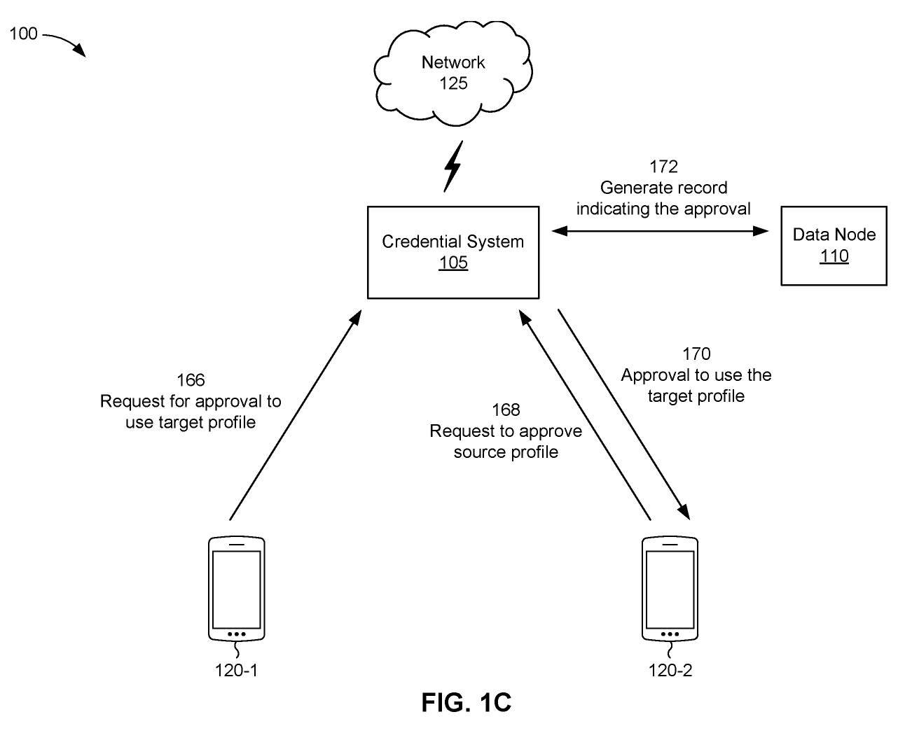

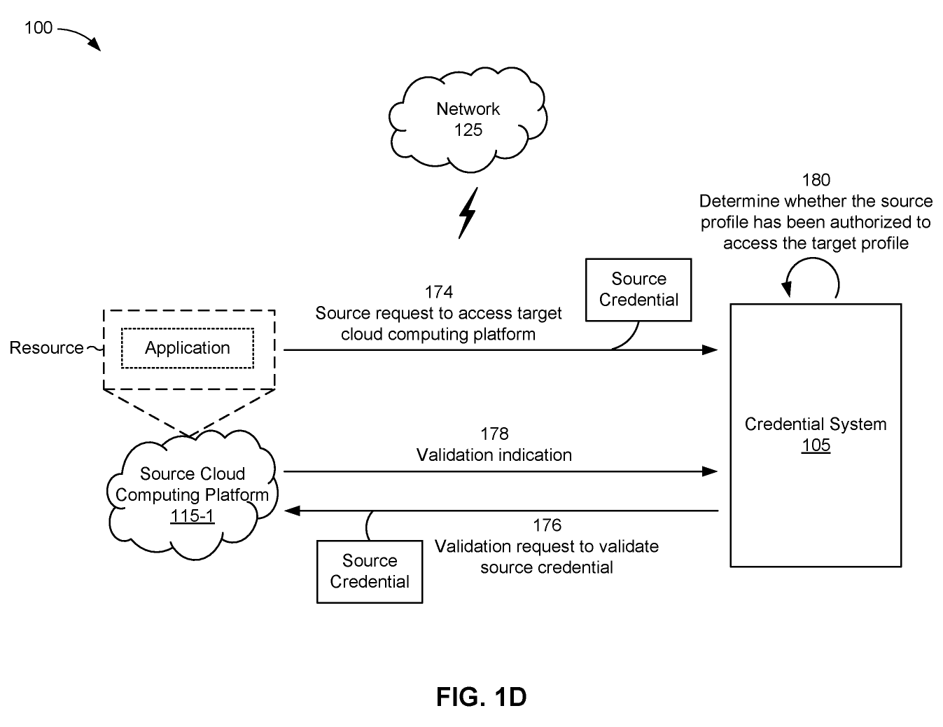

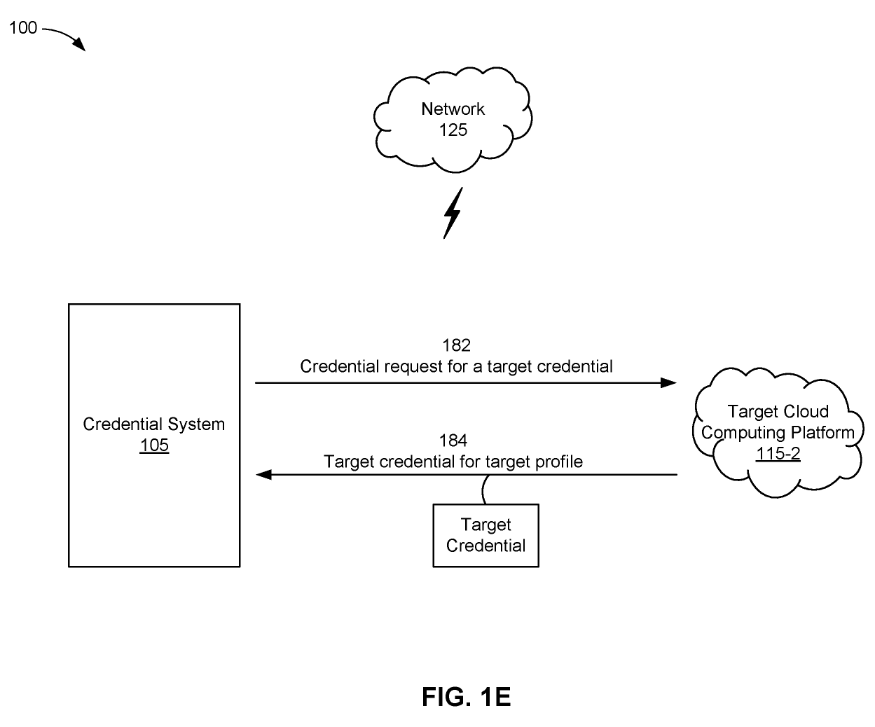

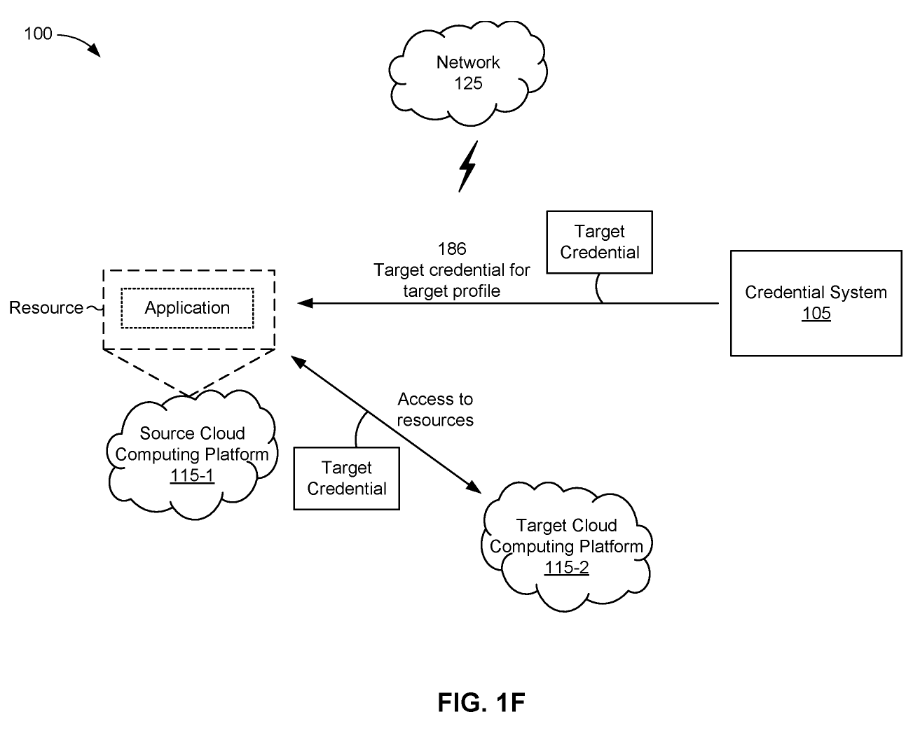

FIGS. 1A-1F show an example environment 100 for multi-cloud access using credential exchange, in accordance with one or more embodiments. As shown, the environment 100 includes a credential system 105, a data node 110, multiple cloud computing platforms 115 (shown as a source cloud computing platform 115-1 and a target cloud computing platform 115-2), multiple user devices 120 (shown as a first user device 120-1 and a second user device 120-2), and/or a network 125.

Communication among the devices and systems of environment 100 may be performed via the network 125. The network 125 may include one or more wired and/or wireless networks. For example, the network 125 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. For example, communications among the devices and systems of environment 100 may be in the form of network messages (e.g., HTTP requests and responses, API requests and responses, or the like).

The data node 110 may include storage, one or more data sources, one or more data services (e.g., accessible via an application programming interface (API)), and/or one or more databases, among other examples. The data node 110 may include, or may be included in, one or more servers. The data node 110 may store information relating to profile registrations, approvals to use profiles, sets of permissions in profiles, and/or resource utilizations of multi-cloud applications, among other examples. The data node 110 may provide any of the aforementioned information to the credential system 105 (e.g., via the network 125). In some implementations, the data node 110 may be a component of the credential system 105.

A cloud computing platform 115 (sometimes referred to as a “cloud environment”) may implement a suite of on-demand computing resources and services designed to support a wide range of applications and workloads. For example, a cloud computing platform 115 may facilitate the building, deployment, and management of applications without the need for physical infrastructure. A cloud computing platform 115 may provide cloud-based processing, storage, and/or databases, among other examples, implemented through a geographically-distributed network of data centers. For example, a cloud computing platform 115 may provide scalable computing resources, scalable storage resources, and/or database management services, among other examples. As an example, a cloud computing platform 115 enables creation and management of virtual servers, serverless compute instances, virtual storage, virtual networking infrastructure, networking configurations, virtual load balancers, container environments, or the like. In some implementations, multiple cloud computing platforms 115-1, 115-2 may be controlled by respective entities, and therefore distinct from one another in terms of infrastructure or service offerings. In some implementations, a source profile (e.g., associated with a first user or entity) may be authorized in the source cloud computing platform 115-1, and a target profile (e.g., associated with the first user or entity, or a second user or entity) may be authorized in the target cloud computing platform 115-2. A “profile” may refer to an account, an identity, or other computing entity associated with a cloud computing platform 115 that defines user-specific or system-specific credentials, permissions, configurations, and/or resource access settings.

A user device 120 may include a communication device and/or a computing device. For example, a user device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. A user device 120 may implement a user interface facilitating user-computer interaction and communication, and may include display screens, keyboards, a mouse, and the appearance of a desktop. For example, a user interface may include a way a user interacts with an application or a website. A user device 120 may exchange data with the credential system 105. For example, data exchanged with the credential system 105 may be in connection with the user device 120 accessing a web page using a web browser installed on the user device 120. In some implementations, a first user device 120-1 may be associated with the source profile (e.g., a user of the first user device 120-1 can access the source profile and/or access credentials for the source profile), and the second user device 120-2 may be associated with the target profile (e.g., a user of the second user device 120-2 can access the target profile and/or access credentials for the target profile). In some implementations, the source profile and the target profile may be associated with the same user or entity, and therefore, the first user device 120-1 and the second user device 120-2 may be the same device.

The credential system 105 may include a communication device and/or a computing device. For example, the credential system 105 may include one or more physical servers, one or more virtual servers (e.g., executing on computing hardware), and/or cloud computing resources (e.g., executing on computing hardware used in a cloud computing environment). In some embodiments, the credential system 105 may be implemented on an edge node of a network or of a cloud system (e.g., in a regional data center of the cloud system). In some embodiments, the credential system 105 may be a component (e.g., a hardware component or a software component) of a user device 120. In some embodiments, user devices 120 may exchange data with the credential system 105 via a web-based interface (e.g., a web portal).

The credential system 105 enables seamless profile interoperability across the cloud computing platforms 115-1, 115-2. The credential system 105 enables trust to be established for profiles in different cloud computing platforms 115-1, 115-2 to facilitate the secure exchange of profiles. For example, through the credential system 105, an application in the source cloud computing platform 115-1 may exchange valid credentials for the source cloud computing platform 115-1 for valid credentials in the target cloud computing platform 115-2, thereby enabling the application to access resources hosted in the target cloud computing platform 115-2. This approach ensures secure, compliant, and consistent multi-cloud resource access.

The credential system 105 may perform operations in an establishment stage (e.g., to establish a trust relationship) and an exchange phase (e.g., to exchange credentials for cloud computing platforms 115). In the establishment stage, the source profile associated with the source cloud computing platform 115-1 and the target profile associated with the target cloud computing platform 115-2 can be registered. For example, as shown in FIG. 1A, and by reference number 150, the credential system 105 may receive, from the second user device 120-2, a request to register the target profile as a profile that can be assumed by profiles outside of the target cloud computing platform 115-2. In some implementations, the credential system 105 may receive the request to register the target profile from a different device associated with the target profile (e.g., in connection with an automated server process). The request to register the target profile provides an indication that the target profile wants to allow profiles in other cloud computing platforms 115, such as the source cloud computing platform 115-1, to assume the target profile. The request to register the target profile may indicate the cloud computing platform 115 that provides the target profile (e.g., the target cloud computing platform 115-2), an identifier for the target profile, and/or a temporary credential (or a non-temporary credential) for the target profile, which provides evidence of ownership of the target profile. “Credential” may refer to authentication data, such as a username, a password, a cryptographic key, a token, and/or a certificate associated with a profile that is used to access resources within a cloud computing platform 115. “Temporary credential” may refer to a credential for a profile that is valid for a limited duration and is typically issued dynamically to grant time-restricted access to resources within a cloud computing platform 115.

As shown by reference number 152, based on the request to register the target profile, the credential system 105 may transmit, to the target cloud computing platform 115-2, a request to validate the temporary credential. For example, the credential system 105 may transmit the request via a target platform API (e.g., an API exposed by the target cloud computing platform 115-2). The request may include the temporary credential. As shown by reference number 154, in response to the request to validate, the credential system 105 may receive, from the target cloud computing platform 115-2, an indication of whether the temporary credential is valid (e.g., whether the temporary credential was validly issued for the target profile). For example, the credential system 105 may receive the indication via the target platform API. In some examples, the indication mayalso indicate an identifier for the target profile (e.g., if such an identifier was not included in the request to register the target profile).

As shown by reference number 156, based on the indication that the temporary credential is valid, the credential system 105 may register the target profile as a profile that can be assumed by profiles outside of the target cloud computing platform 115-2. The registration therefore allows other profiles to assume the identity of the target profile and use resources of the target cloud computing platform 115-2 under the identity of the target profile. To register the target profile, the credential system 105 may generate a record in a database (e.g., of the data node 110) indicating the registration of the target profile.

Prior to, concurrently with, or after receiving the request to register the target account, as shown in FIG. 1B, and by reference number 158, the credential system 105 may receive, from the first user device 120-1, a request to register the source profile as a profile that can assume profiles outside of the source cloud computing platform 115-1. In some implementations, the credential system 105 may receive the request to register the source profile from a different device associated with the source profile (e.g., in connection with an automated server process). The request to register the source profile provides an indication that the source profile wants to be allowed to assume profiles in other cloud computing platforms 115, such as the target cloud computing platform 115-2. The request to register the source profile may indicate the cloud computing platform 115 that provides the source profile (e.g., the source cloud computing platform 115-1), an identifier for the source profile, and/or a temporary credential (or a non-temporary credential) for the source profile, which provides evidence of ownership of the source profile.

As shown by reference number 160, based on the request to register the source profile, the credential system 105 may transmit, to the source cloud computing platform 115-1, a request to validate the temporary credential, in a similar manner as described for the target profile. For example, the credential system 105 may transmit the request via a source platform API (e.g., an API exposed by the source cloud computing platform 115-1). As shown by reference number 162, in response to the request to validate, the credential system 105 may receive, from the source cloud computing platform 115-1, an indication of whether the temporary credential is valid, in a similar manner as described for the target profile. For example, the credential system 105 may receive the indication via the source platform API. As shown by reference number 164, based on the indication that the temporary credential is valid, the credential system 105 may register the source profile as a profile that can assume profiles outside of the source cloud computing platform 115-1, in a similar manner as described for the target profile. The registration therefore allows the source profile to assume the identity of a profile outside of the source cloud computing platform 115-1 and to use resources of another cloud computing platform 115 under the assumed identity.

As shown in FIG. 1C, and by reference number 166, the credential system 105 may receive, from the first user device 120-1, a request for approval to use the target profile. In some implementations, the request for approval may be part of the request to register the source profile rather than a separate request. The request for approval may indicate an identifier of the source profile and an identifier of the target profile. In some implementations, the credential system 105 may receive the request for approval from a different device associated with the source profile (e.g., in connection with an automated server process). As shown by reference number 168, based on the request for approval, the credential system 105 may transmit, to the second user device 120-2, a request to approve the source profile to use the target profile. The request to approve may be in the form of an email, a text message, a push notification, or the like. As shown by reference number 170, the credential system 105 may receive, from the second user device 120-2, approval for the source profile to use the target profile. The approval may be given because the source profile and the target profile are owned by the same entity. As shown by reference number 172, based on receiving the approval, the credential system 105 may generate a record in a database (e.g., of the data node 110) indicating the approval for the source profile to use the target profile. This record therefore establishes a trust relationship between the source profile and the target profile to allow the source profile to subsequently assume the identity of the target profile with a high level of security and consistency.

In some implementations, the credential system 105 may provide automatic approval for the request to use the target profile without seeking approval from the second user device 120-2. For example, the request for approval to use the target profile from the first user device 120-1 may indicate a set of permissions of the source profile for using the target profile in the target cloud computing platform 115-2. For example, the set of permissions may indicate whether the source profile is to have one or more compute permissions (e.g., starting an instance, stopping an instance, terminating an instance, etc.), one or more storage permissions (e.g., reading a file, writing to a file, deleting a filet, etc.), one or more database permissions (e.g., retrieving data from a database, inserting data into a database, deleting data into a database, etc.), and/or one or more identity and access management (IAM) permissions (e.g., creating a user, granting permissions, revoking permissions, etc.), among other examples. Based on the set permissions, the credential system 105 may determine whether the source profile is to be automatically approved to use the target profile. For example, the credential system 105 may automatically approve the source profile to use the target profile based on a determination that the set of permissions is not a security risk (e.g., the permissions allow reading, but do not allow writing, deleting, or modification of infrastructure). Conversely, the credential system 105 may not automatically approve the source profile to use the target profile based on a determination that the set of permissions has a probability to be a security risk. In some implementations, the credential system 105 may input the set of permissions into a machine learning model trained to classify the set of permissions as a security risk or as not a security risk, or to output a score indicating a level of risk of the set of permissions. Based on automatically approving the source profile in accordance with the set of permissions (e.g., without approval from the second user device 120-2), the credential system 105 may generate the record in the database indicating the approval, as described above. The automatic approval process reduces the number of messages transmitted and received by the credential system 105, thereby conserving processing resources of the credential system 105 and network resources.

In some implementations, the target profile may not be in existence at a time of the request for approval to use the target profile. For example, the request for approval to use the target profile from the first user device 120-1 may indicate (or may be indicated by) a request to create the target profile in the target cloud computing platform 115-2. The request may indicate a set of permissions of the source profile for using the target profile in the target cloud computing platform 115-2. Based on the request to create the target profile, the credential system 105 may transmit, to the target cloud computing platform 115-2 (e.g., via the target platform API), a request to create the target profile. In response, the credential system 105 may receive, from the target cloud computing platform 115-2 (e.g., via the target platform API) an indication that the target profile has been created in the target cloud computing platform 115-2. The indication may include an identifier of the target profile that was created. Based on the indication, the credential system 105 may generate the record in the database indicating the approval (e.g., the approval is implied because the target profile is created specifically for the source profile to use), as described above.

The exchange phase may occur during execution (e.g., runtime) of a multi-cloud application implemented on a resource of the source cloud computing platform 115-1. For example, code of the multi-cloud application may include one or more API calls to the credential system 105 that initiate the exchange phase. A “multi-cloud application” may refer to an application that is deployed across and/or utilizes resources from, two or more distinct cloud computing platforms 115. The multi-cloud application therefore enables interoperability, redundancy, and/or optimized performance across different cloud computing platforms 115.

As shown in FIG. 1D, and by reference number 174, the credential system 105 may receive, from the resource (e.g., with the multi-cloud application) of the source cloud computing platform 115-1, a source request to access resources of the target cloud computing platform 115-2. For example, the source request may indicate that the source profile would like to assume the identity of the target profile in the target cloud computing platform 115-2. The credential system 105 may receive the source request via a credential system API (e.g., an API exposed by the credential system 105). The source request may originate from the multi-cloud application during execution of the multi-cloud application (e.g., an API call coded in the multi-cloud application). The source request may indicate a source credential for the source profile, a target identifier for the target profile, and/or an identifier of the source cloud computing platform 115-1. For example, the source request may indicate a temporary source credential for the source profile. As an example, the multi-cloud application may be executing in the source cloud computing platform 115-1 on a compute instance associated with an IAM role. Continuing with the example, during execution, the multi-cloud application may query an instance metadata service of the source cloud computing platform 115-1 to request and retrieve the temporary source credential for the IAM role, which the multi-cloud application can insert into the source request.

As shown by reference number 176, based on the source request, the credential system 105 may transmit, to the source cloud computing platform 115-1, a validation request to validate the source credential (e.g., the temporary source credential). For example, the validation request may indicate that the credential system 105 would like to find out whether the source credential is a valid credential in the source cloud computing platform 115-1 and/or would like to find out the identity of the profile in the source cloud computing platform 115-1 that was issued the source credential. The credential system 105 may transmit the validation request via the source platform API. The validation request may indicate the source credential. Upon receiving the source request, the source cloud computing platform 115-1 may evaluate the validity of the source credential (e.g., by comparing the received source credential to stored credential data) to determine whether the source credential is valid.

As shown by reference number 178, in response to the validation request, the credential system 105 may receive, from the source cloud computing platform 115-1, a validation indication indicating whether the source credential is valid. For example, the validation indication may indicate that the source credential is valid when the source cloud computing platform 115-1 has determined that the source credential is valid. The credential system 105 may receive the validation indication via the source platform API. In some implementations, the validation indication may provide a binary indication of validity (e.g., valid or invalid). In some implementations, the validation indication may include a source identifier for the source profile if the source credential is valid, or may include an empty or null source identifier if the source credential is invalid.

As shown by reference number 180, the credential system 105 may determine whether the source profile has been authorized to access the target profile. For example, the credential system 105 may determine whether a trust relationship was established between the source profile and the target profile in the establishment stage. To determine whether the source profile has been authorized to access the target profile, the credential system 105 may use a database lookup (e.g., query the data node 110) based on the source identifier and/or the target identifier. For example, the credential system 105 may query a database with the source identifier and/or the target identifier to identify whether there is a record indicating approval for the source profile to use the target profile.

In some implementations, the original source request may not indicate a particular target profile and/or a particular target cloud computing platform that is being requested. For example, the source request may indicate that the source profile would like to assume the identity of any target profile in any target cloud computing platform. In this case, the credential system 105 may select a particular target profile and/or a particular target cloud computing platform for the source profile. For example, the source request may indicate information relating to the multi-cloud application, and the credential system 105 may select a particular target profile and/or a particular target cloud computing platform for the source profile based on the information relating to the multi-cloud application. The information relating to the multi-cloud application may indicate an identifier of the multi-cloud application, a description of the multi-cloud application, and/or a resource utilization (e.g., a structured cloud infrastructure configuration) relating to the multi-cloud application. The identifier or the description may enable the credential system 105 to identify the resource utilization. For example, the credential system 105 may maintain a mapping of application identifiers to resource utilizations. As another example, the credential system 105 may input the description into a large language model (LLM), and the credential system 105 may receive, from the LLM, an output indicating the resource utilization. The resource utilization may indicate a cloud infrastructure configuration, such as which cloud services are used by the multi-cloud application (e.g., compute services, database services, storage services, etc.) and/or computing needs of the multi-cloud application (e.g., processing needs, memory needs, storage needs, etc.).

In one example, based on the resource utilization relating to the multi-cloud application, the credential system 105 may select a first cloud computing platform or a second cloud computing platform (or from among more than two cloud computing platforms) to be the target cloud computing platform. For example, the credential system 105 may compare the resource utilization to the capabilities, the availability, and/or the capacities of the first and second cloud computing platforms in order to select a cloud computing platform that is most suitable for the multi-cloud application. As an example, the first cloud computing platform may offer more extensive database services than the second cloud computing platform, and the credential system 105 could select the first cloud computing platform if the resource utilization of the multi-cloud application indicates a heavy reliance on databases.

In some implementations, the original source request may indicate geographic locations of one or more data centers (e.g., where physical devices are located) implementing the resource for the multi-cloud application. For example, the source request may indicate cities, states, and/or countries (e.g., using location codes, abbreviations, or full names). As another example, the source request may indicate an IP address that indicates a geographic location. The credential system 105 may select a first cloud computing platform or a second cloud computing platform (or from among more than two cloud computing platforms) as the target cloud computing platform based on whether the first cloud computing platform or the second cloud computing platform has data centers in more geographic locations that differ with the one or more geographic locations. For example, the credential system 105 may select the target cloud computing platform that provides the most geographic diversity in combination with the source cloud computing platform. In thisway, the target cloud computing platform is selected to improve the availability or reliability of the multi-cloud application through geographic diversity.

In some embodiments, the credential system 105 may select a first cloud computing platform or a second cloud computing platform (or from among more than two cloud computing platforms) as the target cloud computing platform based on current service information relating to the first cloud computing platform and the second cloud computing platform. For example, the credential system 105 may transmit respective requests for service information to the first cloud computing platform and to the second cloud computing platform, and the credential system 105 may receive respective responses from the first cloud computing platform and from the second cloud computing platform indicating service information. Service information may indicate a current status of one or more services (e.g., a compute service, a storage service, a database service, a network service, or the like) or data centers of a cloud computing platform, such as whether a service or data center is experiencing outages, is experiencing latency (e.g., as well as a measurement of the latency), is experiencing a security threat, is being updated, has a known vulnerability, or the like. Additionally, or alternatively, service information may indicate a hardware configuration used for a service or data center, a software configuration used for a service or data center, or the like. The credential system 105 may select the target cloud computing platform based on which of the first cloud computing platform or the second cloud computing platform is currently offering better service. In some embodiments, the credential system 105 may input the service information into a machine learning model trained to output a service classification (e.g., “good,” “average,” or “bad”) or a service score based on service information, and the credential system 105 may use the output to select the target cloud computing platform.

After selecting the target cloud computing platform, the credential system 105 may select a target profile in the selected target cloud computing platform. For example, the target profile may be selected from among a set of target profiles (e.g., one or more profiles) that the source profile has been approved to access. The credential system 105 may select the target profile that has authorization in the selected target cloud computing platform (e.g., the first cloud computing platform or the second cloud computing platform that is selected as the target cloud computing platform). In some examples, multiple target profiles approved for the source profile may have authorization in the selected target cloud computing platform. Accordingly, the credential system 105 may select one of these target profiles at random or based on criteria, such as the target profiles’ sets of permissions for the source profile (e.g., selecting the target profile that provides the most expansive set of permissions), or the order or amounts in which the target profiles were last used by the source profile (e.g., selecting the target profile that was the least-recently used or least-frequently used), among other examples.

Based on determining that the source profile has been authorized to access the target profile, as shown in FIG. 1E, and by reference number 182, the credential system 105 may transmit, to the target cloud computing platform 115-2, a credential request for a target credential for the target profile. The request for the target credential may request a temporary target credential. The credential system 105 may transmit the credential request via the target platform API. The credential request may indicate an identifier for the target profile. In some implementations, the credential request may indicate an identifier for the source profile and/or a source credential for the source profile to enable the target cloud computing platform 115-2 to establish whether target credentials for the target profile can be issued for the source profile. In other cases, the credential request originating from the credential system 105 may be sufficient to enable the target cloud computing platform 115-2 to determine to issue the target credential (e.g., based on a previous and ongoing relationship between the credential system 105 and the target cloud computing platform 115-2).

As shown by reference number 184, in response to the credential request, the credential system 105 may receive, from the target cloud computing platform 115-2, the target credential (e.g., the temporary target credential) for the target profile. For example, the credential system 105 may receive the target credential via the target platform API. As shown in FIG. 1F, and by reference number 186, the credential system 105 may transmit, to the resource (e.g., with the multi-cloud application) of the source cloud computing platform 115-1, the target credential to the target profile. The credential system 105 may transmit the target credential via the credential system API. By transmitting the target credential, the credential system 105 may return the target credential to the multi-cloud application. Accordingly, the multi-cloud application may assume the identity of the target profile using the target credential, and may access resources of the target cloud computing platform using the target profile. For example, the multi-cloud application may communicate with the target cloud computing platform 115-2 via the target platform API and using the target credential (e.g., until an expiration of the target credential if it is a temporary target credential). In this way, the multi-cloud application may use multiple cloud computing platforms in a seamless, secure, and consistent manner.

In some implementations, rather than the credential system 105 returning the target credential to the multi-cloud application, the credential system 105 may store the target credential (e.g., in association with the source credential) on behalf of the multi-cloud application. Subsequently, the resource of the multi-cloud application may transmit communications, that are intended for the target cloud computing platform 115-2, to the credential system 105 using the source credential. The credential system 105 may then resolve the source credential into the target credential, and forward the communications to the target cloud computing platform 115-2 using the target credential. Similarly, the credential system 105 may receive communications, that are intended for the resource of the multi-cloud application, from the target cloud computing platform 115-2 using the target credential. The credential system 105 may then resolve the target credential into the source credential, and forward the communications to the resource of the multi-cloud application using the source credential.

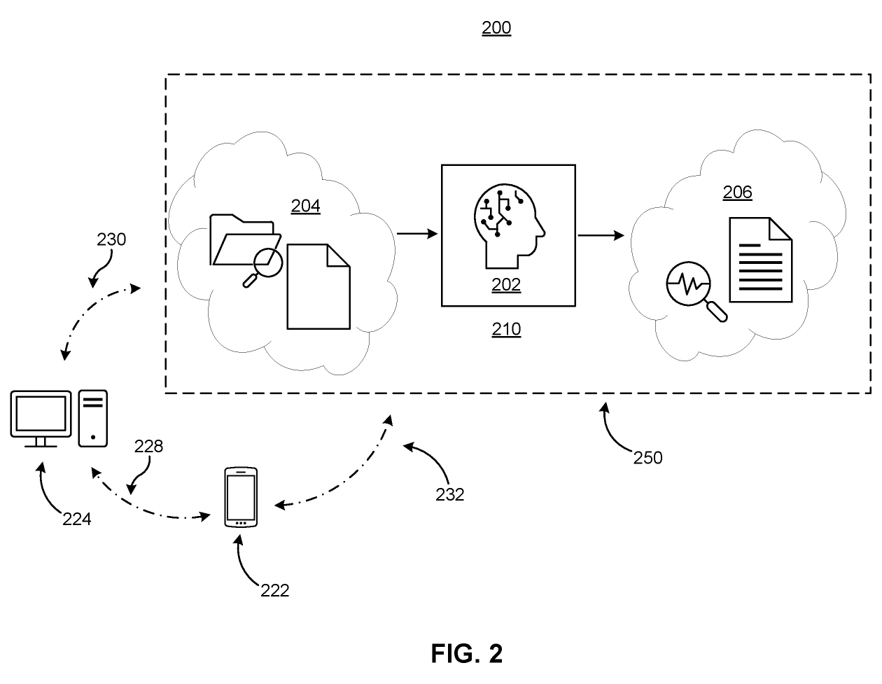

FIG. 2 shows illustrative components for a system used to enable multi-cloud resource utilization, in accordance with one or more embodiments. For example, FIG. 2 may show illustrative components for multi-cloud access using credential exchange. As shown in FIG. 2, system 200 may include mobile device 222 and user terminal 224. While shown as a smartphone and personal computer, respectively, in FIG. 2, it should be noted that mobile device 222 and user terminal 224 may be any computing device, including, but not limited to, a laptop computer, a tablet computer, a hand-held computer, and other computer equipment (e.g., a server), including “smart,” wireless, wearable, and/or mobile devices. FIG. 2 also includes cloud components 210. Cloud components 210 may alternatively be any computing device as described above, and may include any type of mobile terminal, fixed terminal, or other device. For example, cloud components 210 may be implemented as a cloud computing platform, and may feature one or more component devices. It should also be noted that system 200 is not limited to three devices. Users may, for instance, utilize one or more devices to interact with one another, one or more servers, or other components of system 200. It should be noted, that, while one or more operations are described herein as being performed by particular components of system 200, these operations may, in some embodiments, be performed by other components of system 200. As an example, while one or more operations are described herein as being performed by components of mobile device 222, these operations may, in some embodiments, be performed by components of cloud components 210. In some embodiments, the various computers and systems described herein may include one or more computing devices that are programmed to perform the described functions. Additionally, or alternatively, multiple users may interact with system 200 and/or one or more components of system 200. For example, in one embodiment, a first user and a second user may interact with system 200 using two different components.

With respect to the components of mobile device 222, user terminal 224, and cloud components 210, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 2, both mobile device 222 and user terminal 224 include a display upon which to display data (e.g., conversational response, queries, and/or notifications).

Additionally, as mobile device 222 and user terminal 224 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 200 may run an application (or another suitable program). The application may cause the processors and/or control circuitry to perform operations related to generating requests and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electricalcharge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 2 also includes communication paths 228, 230, and 232. Communication paths 228, 230, and 232 may include the Internet, a mobile phone network, a mobile voice or data network (e.g., a 5G or LTE network), a cable network, a public switched telephone network, or other types of communications networks or combinations of communications networks. Communication paths 228, 230, and 232 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 210 may include the credential system 105 and/or the data node 110. In some implementations, one or more cloud computing platforms 115 may correspond to cloud components 210. Cloud components 210 may include model 202, which may be a machine learning model, artificial intelligence model, etc. (which may be referred collectively as “models” herein). Model 202 may take inputs 204 and provide outputs 206. The inputs may include multiple datasets, such as a training dataset and a test dataset. Each of the plurality of datasets (e.g., inputs 204) may include data subsets related to user data, predicted forecasts and/or errors, and/or actual forecasts and/or errors. In some embodiments, outputs 206 may be fed back to model 202 as input to train model 202 (e.g., alone or in conjunction with user indications of the accuracy of outputs 206, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether a set of permission is a security risk or not a security risk).

In a variety of embodiments, model 202 may update its configurations (e.g., weights, biases, or other parameters) based on the assessment of its prediction (e.g., outputs 206) and reference feedback information (e.g., user indication of accuracy, reference labels, or other information). In a variety of embodiments, where model 202 is a neural network, connection weights may be adjusted to reconcile differences between the neural network’s prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 202 may be trained to generate better predictions.

In some embodiments, model 202 may include an artificial neural network. In such embodiments, model 202 may include an input layer and one or more hidden layers. Each neural unit of model 202 may be connected with many other neural units of model 202. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 202 may be self-learning and trained, rather than explicitly programmed, and can perform significantly better in certain areas of problem solving, as compared to traditional computer programs. During training, an output layer of model 202 may correspond to a classification of model 202, and an input known to correspond to that classification may be input into an input layer of model 202 during training. During testing, an input without a known classification may be input into the input layer, and a determined classification may be output.

In some embodiments, model 202 may include multiple layers (e.g., where a signal path traverses from front layers to back layers). In some embodiments, back propagation techniques may be utilized by model 202 where forward stimulation is used to reset weights on the “front” neural units. In some embodiments, stimulation and inhibition for model 202 may be more free-flowing, with connections interacting in a more chaotic and complex fashion. During testing, anoutput layer of model 202 may indicate whether or not a given input corresponds to a classification of model 202 (e.g., whether a set of permissions is a security risk or not a security risk).

In some embodiments, the model (e.g., model 202) may automatically perform actions based on outputs 206. In some embodiments, the model (e.g., model 202) may not perform any actions. The output of the model (e.g., model 202) may be used to automatically approve a source profile in one cloud computing platform to use a target profile in another cloud computing platform.

System 200 also includes API layer 250. API layer 250 may include, correspond to, or implement the target platform API, the source platform API, or the credential system API. In some embodiments, API layer 250 may be implemented on mobile device 222 or user terminal 224. Alternatively or additionally, API layer 250 may reside on one or more of cloud components 210. API layer 250 (which may be A REST or Web services API layer) may provide a decoupled interface to data and/or functionality of one or more applications. API layer 250 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 250 may use various architectural arrangements. For example, system 200 may be partially based on API layer 250, such that there is strong adoption of SOAP and RESTful Web-services, using resources like Service Repository and Developer Portal, but with low governance, standardization, and separation of concerns. Alternatively, system 200 may be fully based on API layer 250, such that separation of concerns between layers like API layer 250, services, and applications are in place.

In some embodiments, the system architecture may use a microservice approach. Such systems may use two types of layers: Front-End Layer and Back-End Layer where microservices reside. In this kind of architecture, the role of the API layer 250 may provide integration between Front-End and Back-End. In such cases, API layer 250 may use RESTful APIs (exposition to front-end or even communication between microservices). API layer 250 may use AMQP (e.g.,Kafka, RabbitMQ, etc.). API layer 250 may use incipient usage of new communications protocols such as gRPC, Thrift, etc.

In some embodiments, the system architecture may use an open API approach. In such cases, API layer 250 may use commercial or open source API Platforms and their modules. API layer 250 may use a developer portal. API layer 250 may use strong security constraints applying WAF and DDoS protection, and API layer 250 may use RESTful APIs as standard for external integration.

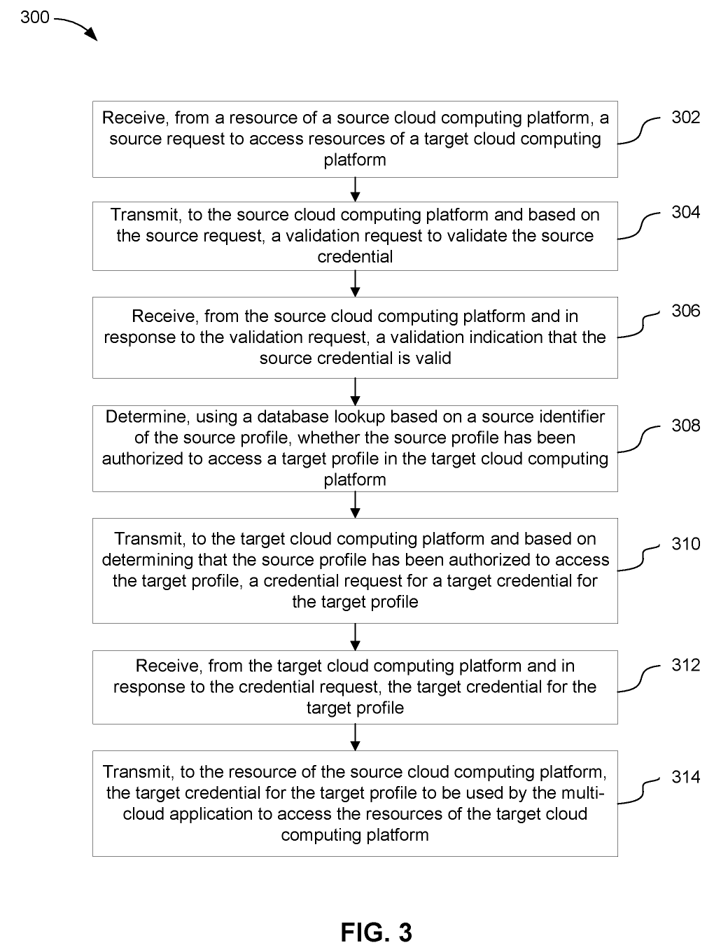

FIG. 3 shows a flowchart of the steps involved in enabling efficient multi-cloud resource utilization, in accordance with one or more embodiments. For example, the system may use process 300 (e.g., as implemented on one or more system components described above) in order to enable multi-cloud resource utilization, grant access to resources across cloud computing platforms, or authorize the use of resources across cloud computing platforms, among other examples.

At step 302, process 300 (e.g., using one or more components described above) may include receiving a source request to access resources of a target cloud computing platform. For example, the system may receive, from a resource of a source cloud computing platform, a source request to access resources of a target cloud computing platform. The source request may originate from a multi-cloud application on the resource of the source cloud computing platform. The source request may indicate a source credential for a source profile authorized in the source cloud computing platform. As described in connection with reference number 174 of FIG. 1D, the source request may indicate that the source profile would like to assume the identity of the target profile in the target cloud computing platform. The source request may be made via a network message (e.g., an API request) that provides direct and efficient communication between the system and the resource of the source cloud computing platform, reducing latency and ensuring timely access to the requested resources. Furthermore, the source request enables the multi-cloud application to dynamically request access to resources in the target cloud computing platform at runtime, providing seamless interoperability without requiring preconfigured credentials or static access permissions. The source request also allows the multi-cloud application to leverage resources across multiple cloud computing platforms, optimizing efficiency, performance, and availability based on real-time demands of the multi-cloud application. Additionally, this setup enhancesscalability and fault tolerance by enabling workloads to shift between cloud computing platforms as needed.

In some embodiments, the source request may indicate a resource utilization relating to the multi-cloud application, and process 300 may include selecting, based on the resource utilization relating to the multi-cloud application, a first cloud computing platform or a second cloud computing platform as the target cloud computing platform. By doing so, the system enables the multi-cloud application to utilize the most suitable infrastructure for its workload, optimizing performance, scalability, and availability. This allows the multi-cloud application to take advantage of specialized services, such as high-performance GPUs, low-latency networking, or region-specific data centers, depending on its needs. Additionally, dynamically choosing the best cloud computing platform for the multi-cloud application enhances reliability and fault tolerance by distributing workloads across multiple cloud computing platforms, reducing the risk of service disruptions. In some embodiments, process 300 may include selecting the target profile, from among target profiles having authorization in the selected target cloud computing platform, based on a set of permission of the source profile for using the target profile. Selecting the target profile based on the set of permissions allows the multi-cloud application to access a broader range of resources and perform necessary operations without unnecessary restrictions, thereby facilitating efficient use of resources in the target cloud computing platform.

In some embodiments, the source request may indicate one or more geographic locations of one or more data centers implementing the resource, an process 300 may include selecting a first cloud computing platform or a second cloud computing platform as the target cloud computing platform based on whether the first cloud computing platform or the second cloud computing platform has data centers in more geographic locations that differ with the one or more geographic locations. By doing so, the system enhances redundancy and disaster recovery by reducing the risk of service disruptions from regional outages. Geographic distribution improves data availability, ensuring that the multi-cloud application remains operational even if one cloud computing platform experiences a failure in a specific region. Additionally, leveraging multiple geographic locations can optimize latency for users in different regions, enhancing overall performance of the multi-cloud application.

At step 304, process 300 (e.g., using one or more components described above) may include transmitting a validation request to validate the source credential. For example, the systemmay transmit, to the source cloud computing platform and based on the source request, a validation request to validate the source credential. As described in connection with reference number 176 of FIG. 1D, the validation request may indicate that the system would like to find out whether the source credential is a valid credential in the source cloud computing platform and/or would like to find out the identity of the profile in the source cloud computing platform that was issued the source credential. At step 306, process 300 (e.g., using one or more components described above) may include receiving a validation indication that the source credential is valid. For example, the system may receive, from the source cloud computing platform and in response to the validation request, a validation indication that the source credential is valid. As described in connection with reference number 178 of FIG. 1D, the validation indication may indicate that the source credential is valid when the source cloud computing platform has determined (e.g., by comparing the received source credential to stored credential data) that the source credential is valid. Communications for validating the credential may use network messages (e.g., an API request and response) that provide direct and efficient communication between the system and the source cloud computing platform, reducing latency and ensuring timely access to the requested resources. Moreover, by validating the credential, the system may prevent unauthorized access, ensuring that only verified profiles or applications can interact with resources in the target cloud computing platform. Furthermore, the validation request and validation indication serve as a way for the system to identify the source profile using a single, low-weight request and response with the source cloud computing platform and without requiring the system to store identity data or use complex identity tracking schemes.

At step 308, process 300 (e.g., using one or more components described above) may include determining whether the source profile has been authorized to access a target profile in the target cloud computing platform. For example, the system may determine, using a database lookup based on a source identifier of the source profile, whether the source profile has been authorized to access a target profile in the target cloud computing platform. As described in connection with reference number 180 of FIG. 1D, the system may query a database with the source identifier and/or the target identifier to identify whether there is a record indicating approval for the source profile to use the target profile. By doing so, the system reduces unauthorized access and resource usage. Reducing unauthorized access and resource usage conserves processor, memory, and/or networking resources by stopping malicious or unnecessary requests from consuming system capacity, which helps maintain efficient performance for legitimate uses. It also minimizes the overhead associated with logging, monitoring, and/or mitigating unauthorized activities, allowing resources to be allocated more efficiently to legitimate workloads.

At step 310, process 300 (e.g., using one or more components described above) may include transmitting a credential request for a target credential for the target profile. For example, the system may transmit, to the target cloud computing platform and based on determining that the source profile has been authorized to access the target profile, a credential request for a target credential for the target profile. As described in connection with reference number 182 of FIG. 1E, the request for the target credential may request a temporary target credential, which will allow the multi-cloud application to use resources in the target cloud computing platform for a limited duration. At step 312, process 300 (e.g., using one or more components described above) may include receiving the target credential for the target profile. For example, the system may receive, from the target cloud computing platform and in response to the credential request, the target credential for the target profile. Communications for the target credential may use network messages (e.g., an API request and response) that provide direct and efficient communication between the system and the target cloud computing platform, reducing latency and ensuring timely access to the requested resources. Furthermore, real-time requests allow the credentials to be issued dynamically, thereby reducing the need for long-term credential storage and tracking, which consumes additional computing resources. Moreover, the temporary credential allows access to resources in the target cloud computing platform only when needed, reducing idle resource consumption and minimizing security risks. The temporary credential also limits unnecessary privilege persistence, thereby conserving processing resources and memory resources that would otherwise be allocated for data persistence.

At step 314, process 300 (e.g., using one or more components described above) may include transmitting the target credential for the target profile. For example, the system may transmit, to the resource of the source cloud computing platform, the target credential for the target profile. This allows the target credential to be used by the multi-cloud application to access the resources of the target cloud computing platform. As described in connection with reference number 184 of FIG. 1F, the multi-cloud application may assume the identity of the target profile using the target credential, and may access resources of the target cloud computing platform using the target profile. The target credential may be communicated via a network message (e.g., an API response) that provides direct and efficient communication between the system and the resource of the source cloud computing platform, reducing latency and ensuring timely access to the requested resources. By managing the issuance of the target credential to the multi-cloud application, the system allows the multi-cloud application to leverage resources across multiple cloud computing platforms, optimizing efficiency, performance, and availability based on real-time demands of the multi-cloud application. Thus, by enabling multi-cloud resource utilization, the system conserves processing and memory resources that otherwise would be used less efficiently in a single-cloud setup.

In some embodiments, process 300 may include receiving a request to register the target profile as a profile that can be assumed by profiles outside of the target cloud computing platform. The request to register the target profile may indicate a temporary credential for the target profile. Process 300 may further include transmitting, to the target cloud computing platform, an additional request to validate the temporary credential, receiving, from the target cloud computing platform and in response to the additional request, an indication that the temporary credential is valid, and registering, based on the indication that the temporary credential is valid, the target profile as a profile that can be assumed by profiles outside of the target cloud computing platform. Doing so enhances security by ensuring that only authenticated profiles can be added to the system, reducing the risk of unauthorized or fraudulent registrations, thereby conserving computing resources that otherwise may be consumed handling fraudulent registrations.

In some embodiments, process 300 may include receiving a request to register the source profile as a profile that can assume profiles outside of the source cloud computing platform. The request to register the source profile indicates a temporary credential for the source profile. Process 300 may further include transmitting, to the source cloud computing platform, an additional request to validate the temporary credential, receiving, from the source cloud computing platform and in response to the additional request, an indication that the temporary credential is valid, and registering, based on the indication that the temporary credential is valid, the source profile as a profile that can assume profiles outside of the source cloud computing platform. Doing so enhances security by ensuring that only authenticated profiles can be added to the system, reducing the risk of unauthorized or fraudulent registrations, thereby conserving computing resources that otherwise may be consumed handling fraudulent registrations.

In some embodiments, process 300 may include receiving, from a first device associated with the source profile, a first request for approval to use the target profile, transmitting, to a second device associated with the target profile and based on the first request, a second request to approve the source profile to use the target profile, receiving, from the second device, approval for the source profile to use the target profile, and generating a record in a database indicating the approval for the source profile to use the target profile. This reduces fraudulent access to the target cloud computing platform, thereby improving cybersecurity and conserving computing resources that otherwise may be expended logging, monitoring, and/or mitigating unauthorized activities.

In some embodiments, process 300 may include receiving, from a device associated with the source profile, a request for approval to use the target profile, where the request indicates a set of permissions of the source profile for using the target profile, determining, based on the set of permissions, whether the source profile is to be approved to use the target profile, and generating a record in a database indicating approval for the source profile to use the target profile based on approving the source profile in accordance with the set of permissions. In some embodiments, determining whether the source profile is to be approved to use the target profile may include inputting the set of permissions into a model trained to classify the set of permissions as a security risk or as not a security risk, and determining whether the source profile is to be approved based on a classification of the set of permission as a security risk or as not a security risk. By doing so, approval can be determined using fewer network messages, thereby conserving processor resources and network resources that otherwise would be consumed generating and communicating the network messages.

In some embodiments, process 300 may include receiving, from a device associated with the source profile, a first request to create the target profile in the target cloud computing platform, transmitting, to the target cloud computing platform and based on the first request, a second request to create the target profile, receiving, from the target cloud computing platform and in response to the second request, an indication that the target profile has been created in the target cloud computing platform, and generating a record in a database indicating approval for the source profile to use the target profile responsive to receiving the indication. By doing so, approval can be determined using fewer network messages, thereby conserving processor resources and network resources that otherwise would be consumed generating and communicating the network messages.

It is contemplated that the steps or descriptions of FIG. 3 may be used with any other embodiment of this disclosure. In addition, the steps and descriptions described in relation to FIG. 3 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 3.

In some implementations, an Application-Specific Integrated Circuit (ASIC) may be configured to perform operations described herein. An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model’s computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC’s capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for multi-cloud access using credential exchange.
2. The method of embodiment 1 comprising: receiving, from a resource of a source cloud computing platform, a source request to access resources of a target cloud computing platform, wherein the source request originates from a multi-cloud application on the resource of the source cloud computing platform, and wherein the source request indicates a source credential for a source profile authorized in the source cloud computing platform; transmitting, to the source cloud computing platform and based on the source request, a validation request to validate the source credential; receiving, from the source cloud computing platform and in response to the validation request, a validation indication that the source credential is valid; determining, using a database lookup based on a source identifier of the source profile, whether the source profile has been authorized to access a target profile in the target cloud computing platform; transmitting, to the target cloud computing platform and based on determining that the source profile has been authorized to access the target profile, a credential request for a target credential for the target profile; receiving, from the target cloud computing platform and in response to the credential request, the target credential for the target profile; and transmitting, to the resource of the source cloud computing platform, the target credential for the target profile to be used by the multi-cloud application to access the resources of the target cloud computing platform.
3. The method of any of embodiments 1-2, wherein the source request indicates a resource utilization relating to the multi-cloud application, and the method further comprises: selecting, based on the resource utilization relating to the multi-cloud application, a first cloud computing platform or a second cloud computing platform as the target cloud computing platform.
4. The method of embodiment 3, wherein determining whether the source profile has been authorized to access the target profile comprises: selecting the target profile, from among a set of target profiles that the source profile has been approved to access, based on the target profile having authorization in the first cloud computing platform or the second cloud computing platform that is selected as the target cloud computing platform.
5. The method of embodiment 4, wherein selecting the target profile comprises: selecting the target profile, from among multiple target profiles having the authorization, based on a set of permissions of the source profile for using the target profile.
6. The method of any of embodiments 1-5, wherein the source request indicates one or more geographic locations of one or more data centers implementing the resource, and the method further comprises: selecting a first cloud computing platform or a second cloud computing platform as the target cloud computing platform based on whether the first cloud computing platform or the second cloud computing platform has data centers in more geographic locations that differ with the one or more geographic locations.
7. The method of any of embodiments 1-6, further comprising: receiving a request to register the target profile as a profile that can be assumed by profiles outside of the target cloud computing platform.
8. The method of embodiment 7, wherein the request to register the target profile indicates a temporary credential for the target profile, and the method further comprises: transmitting, to the target cloud computing platform, an additional request to validate the temporary credential; receiving, from the target cloud computing platform and in response to the additional request, an indication that the temporary credential is valid; and registering, based on the indication that the temporary credential is valid, the target profile as a profile that can be assumed by profiles outside of the target cloud computing platform.
9. The method of any of embodiments 1-8, further comprising: receiving a request to register the source profile as a profile that can assume profiles outside of the source cloud computing platform.
10. The method of embodiment 9, wherein the request to register the source profile indicates a temporary credential for the source profile, and the method further comprises: transmitting, to the source cloud computing platform, an additional request to validate the temporary credential; receiving, from the source cloud computing platform and in response to the additional request, an indication that the temporary credential is valid; and registering, based on the indication that the temporary credential is valid, the source profile as a profile that can assume profiles outside of the source cloud computing platform.
11. The method of any of embodiments 1-10, further comprising: receiving, from a first device associated with the source profile, a first request for approval to use the target profile; transmitting, to a second device associated with the target profile and based on the first request, a second request to approve the source profile to use the target profile; receiving, from the second device, approval for the source profile to use the target profile; and generating a record in a database indicating the approval for the source profile to use the target profile.
12. The method of any of embodiments 1-11, further comprising: receiving, from a device associated with the source profile, a request for approval to use the target profile, wherein the request indicates a set of permissions of the source profile for using the target profile; determining, based on the set of permissions, whether the source profile is to be approved to use the target profile; and generating a record in a database indicating approval for the source profile to use the target profile based on approving the source profile in accordance with the set of permissions.
13. The method of embodiment 12, wherein determining whether the source profile is to be approved to use the target profile comprises: inputting the set of permissions into a model trained to classify the set of permissions as a security risk or as not a security risk; and determining whether the source profile is to be approved based on a classification of the set of permission as a security risk or as not a security risk.
14. The method of any of embodiments 1-13, further comprising: receiving, from a device associated with the source profile, a first request to create the target profile in the target cloud computing platform; transmitting, to the target cloud computing platform and based on the first request, a second request to create the target profile; receiving, from the target cloud computing platform and in response to the second request, an indication that the target profile has been created in the target cloud computing platform; and generating a record in a database indicating approval for the source profile to use the target profile responsive to receiving the indication.
15. One or more non-transitory, computer-readable mediums storing instructions that, when executed by a data processing apparatus, cause the data processing apparatus to perform operations comprising those of any of embodiments 1-14.
16. A system comprising one or more processors; and memory storing instructions that, when executed by the processors, cause the processors to effectuate operations comprising those of any of embodiments 1-14.
17. A system comprising means for performing any of embodiments 1-14.

What is claimed is:

1. A system for multi-cloud access using credential exchange, the system comprising:
one or more memories and one or more processors, communicatively coupled to the one or more memories, configured to cause the system to:
receive, via a first API from a resource of a source cloud computing platform, a source request to access resources of a target cloud computing platform,
wherein the source request originates from a multi-cloud application on the resource of the source cloud computing platform, and
wherein the source request indicates a temporary source credential for a source profile authorized in the source cloud computing platform, and indicates a target identifier for a target profile authorized in the target cloud computing platform;
transmit, via a second API to the source cloud computing platform and based on the source request, a validation request to validate the temporary source credential;
receive, via the second API from the source cloud computing platform and in response to the validation request, a validation indication that the temporary source credential is valid,
wherein the validation indication includes a source identifier for the source profile;
determine, using a database lookup based on the source identifier and the target identifier, whether the source profile has been authorized to access the target profile;
transmit, via a third API to the target cloud computing platform and based on determining that the source profile has been authorized to access the target profile, a credential request for a temporary target credential for the target profile;
receive, via the third API from the target cloud computing platform and in response to the credential request, the temporary target credential for the target profile; and
transmit, via the first API to the resource of the source cloud computing platform, the temporary target credential for the target profile to be used by the multi-cloud application to access the resources of the target cloud computing platform.

2. A method for multi-cloud access using credential exchange, the method comprising:
receiving, by a device from a resource of a source cloud computing platform, a source request to access resources of a target cloud computing platform,
wherein the source request originates from a multi-cloud application on the resource of the source cloud computing platform, and
wherein the source request indicates a source credential for a source profile authorized in the source cloud computing platform;
transmitting, by the device to the source cloud computing platform and based on the source request, a validation request to validate the source credential;
receiving, by the device from the source cloud computing platform and in response to the validation request, a validation indication that the source credential is valid;
determining, by the device using a database lookup based on a source identifier of the source profile, whether the source profile has been authorized to access a target profile in the target cloud computing platform;
transmitting, by the device to the target cloud computing platform and based on determining that the source profile has been authorized to access the target profile, a credential request for a target credential for the target profile;
receiving, by the device from the target cloud computing platform and in response to the credential request, the target credential for the target profile; and
transmitting, by the device to the resource of the source cloud computing platform, the target credential for the target profile to be used by the multi-cloud application to access the resources of the target cloud computing platform.

3. The method of claim 2, wherein the source request indicates a resource utilization relating to the multi-cloud application, and the method further comprises:
selecting, based on the resource utilization relating to the multi-cloud application, a first cloud computing platform or a second cloud computing platform as the target cloud computing platform.

4. The method of claim 3, wherein determining whether the source profile has been authorized to access the target profile comprises:
selecting the target profile, from among a set of target profiles that the source profile has been approved to access, based on the target profile having authorization in the first cloud computing platform or the second cloud computing platform that is selected as the target cloud computing platform.

5. The method of claim 4, wherein selecting the target profile comprises:
selecting the target profile, from among multiple target profiles having the authorization, based on a set of permissions of the source profile for using the target profile.

6. The method of claim 2, wherein the source request indicates one or more geographic locations of one or more data centers implementing the resource, and the method further comprises:
selecting a first cloud computing platform or a second cloud computing platform as the target cloud computing platform based on whether the first cloud computing platform or the second cloud computing platform has data centers in more geographic locations that differ with the one or more geographic locations.

7. The method of claim 2, further comprising:
receiving a request to register the target profile as a profile that can be assumed by profiles outside of the target cloud computing platform.

8. The method of claim 7, wherein the request to register the target profile indicates a temporary credential for the target profile, and the method further comprises:
transmitting, to the target cloud computing platform, an additional request to validate the temporary credential;
receiving, from the target cloud computing platform and in response to the additional request, an indication that the temporary credential is valid; and
registering, based on the indication that the temporary credential is valid, the target profile as a profile that can be assumed by profiles outside of the target cloud computing platform.

9. The method of claim 2, further comprising:
receiving a request to register the source profile as a profile that can assume profiles outside of the source cloud computing platform.

10. The method of claim 9, wherein the request to register the source profile indicates a temporary credential for the source profile, and the method further comprises:
transmitting, to the source cloud computing platform, an additional request to validate the temporary credential;
receiving, from the source cloud computing platform and in response to the additional request, an indication that the temporary credential is valid; and
registering, based on the indication that the temporary credential is valid, the source profile as a profile that can assume profiles outside of the source cloud computing platform.

11. The method of claim 2, further comprising:
receiving, from a first device associated with the source profile, a first request for approval to use the target profile;
transmitting, to a second device associated with the target profile and based on the first request, a second request to approve the source profile to use the target profile;
receiving, from the second device, approval for the source profile to use the target profile; and
generating a record in a database indicating the approval for the source profile to use the target profile.

12. The method of claim 2, further comprising:
receiving, from a device associated with the source profile, a request for approval to use the target profile,
wherein the request indicates a set of permissions of the source profile for using the target profile;
determining, based on the set of permissions, whether the source profile is to be approved to use the target profile; and
generating a record in a database indicating approval for the source profile to use the target profile based on approving the source profile in accordance with the set of permissions.

13. The method of claim 12, wherein determining whether the source profile is to be approved to use the target profile comprises:
inputting the set of permissions into a model trained to classify the set of permissions as a security risk or as not a security risk; and
determining whether the source profile is to be approved based on a classification of the set of permissions as a security risk or as not a security risk.

14. The method of claim 2, further comprising:
receiving, from a device associated with the source profile, a first request to create the target profile in the target cloud computing platform;
transmitting, to the target cloud computing platform and based on the first request, a second request to create the target profile;
receiving, from the target cloud computing platform and in response to the second request, an indication that the target profile has been created in the target cloud computing platform; and
generating a record in a database indicating approval for the source profile to use the target profile responsive to receiving the indication.

15. A non-transitory, computer-readable medium, comprising instructions that, when executed by one or more processors, cause operations comprising:
receiving, from a resource of a source cloud computing platform, a source request to access resources of a target cloud computing platform,
wherein the source request originates from a multi-cloud application on the resource of the source cloud computing platform, and
wherein the source request indicates a source profile authorized in the source cloud computing platform;
determining whether the source profile has been authorized to access a target profile in the target cloud computing platform;
transmitting, to the target cloud computing platform and based on determining that the source profile has been authorized to access the target profile, a credential request for a target credential for the target profile;
receiving, from the target cloud computing platform and in response to the credential request, the target credential for the target profile; and
transmitting, to the resource of the source cloud computing platform, the target credential for the target profile to be used by the multi-cloud application to access the resources of the target cloud computing platform.

16. The non-transitory, computer-readable medium of claim 15, wherein the instructions further cause operations comprising:
selecting, based on a resource utilization relating to the multi-cloud application, a first cloud computing platform or a second cloud computing platform as the target cloud computing platform.

17. The non-transitory, computer-readable medium of claim 16, wherein determining whether the source profile has been authorized to access the target profile comprises:
selecting the target profile, from among a set of target profiles that the source profile has been approved to access, based on the target profile having authorization in the first cloud computing platform or the second cloud computing platform that is selected as the target cloud computing platform.

18. The non-transitory, computer-readable medium of claim 17, wherein selecting the target profile comprises:
selecting the target profile, from among multiple target profiles having the authorization, based on a set of permissions of the source profile for using the target profile.

19. The non-transitory, computer-readable medium of claim 15, wherein the instructions further cause operations comprising:
receiving, from a device associated with the source profile, a request for approval to use the target profile,
wherein the request indicates a set of permissions of the source profile for using the target profile;
determining, based on the set of permissions, whether the source profile is to be approved to use the target profile; and
generating a record in a database indicating approval for the source profile to use the target profile based on approving the source profile in accordance with the set of permissions.

20. The non-transitory, computer-readable medium of claim 15, wherein the instructions further cause operations comprising:
receiving, from a device associated with the source profile, a first request to create the target profile in the target cloud computing platform;
transmitting, to the target cloud computing platform and based on the first request, a second request to create the target profile;
receiving, from the target cloud computing platform and in response to the second request, an indication that the target profile has been created in the target cloud computing platform; and
generating a record in a database indicating approval for the source profile to use the target profile responsive to receiving the indication.
